(19) United States
(12) Patent Application Publication
(10) Pub. No.: US 2006/0272712 A1
(43) Pub. Date: Dec. 7, 2006

(54) VALVE WITH END POSITION SWITCHING

(76) Inventor: Rolf Sontag, Schorndorf (DE)

Correspondence Address: Eugene LeDonne;REED SMITH LLP, 599 LEXINGTON AVENUE, NEW YORK, NY, 10022-7650, US

(21) Appl. No.: 11/422,472

(22) Filed: Jun. 6, 2006

(30) Foreign Application Priority Data
Jun. 7, 2005 (DE) 10 2005 026 105.1

(51) Int. Cl. F16K 37/00

(52) U.S. Cl. 137/554

(57) ABSTRACT

For detecting closing or opening of a valve activated preferably by a solenoid actuator, a switch activated by a tappet spring mounted on an armature of the actuator is provided. A stop and an associated surface limit the stroke of the tappet with reference to the switch. Preferably, a valve closing element opens the gas flow only when the armature has already executed a part of its opening stroke. The trigger point of the switch is set in this first part of the opening stroke of the armature, in which the valve closing element has not yet opened. The stroke limiting of the tappet for activating the switch is also preferably set in this region of the opening stroke of the armature. However, the stop limits the stroke of the tappet independent of the opening stroke size of the armature, so that the same switch can be used for different valves with different nominal diameters and opening strokes.

### CROSS-REFERENCE TO RELATED APPLICATIONS

This application claims priority to German Application No. 10 2005 026 105.1, filed Jun. 7, 2005, which is incorporated herein by reference.

### FIELD OF THE INVENTION

The invention relates to a valve with an end position switch for closure recognition.

### BACKGROUND OF THE INVENTION

For safety reasons, it is occasionally necessary to mount end position switches on gas valves or other corresponding valves. These end position switches output a signal with a first signal value when the valve is securely closed and with a second signal value before the valve opens the gas flow. Here, the second signal value can be output when the valve is still closed, but an opening process has already begun. A signal must be changed from its first state to a second state within an extremely precisely defined window with reference to the stroke of the valve closing element, or other elements which are connected to the valve closing element. This window is also designated as “overtravel.”

If an end position switch is installed, for example, retrofitted, at the bottom side of a valve, this arrangement works only if the space under the valve closing element is also available for the installation of an end position switch accordingly. If, for example, a pressure regulator or a flow regulator is arranged in this region, there is no installation space available for an end position switch.

If an end position switch is placed, for example, at the top on the drive used for activating the valve, the end position switch must, on the one hand permit the total stroke of the actuator, and on the other hand respond as soon as the lifting magnet moves, even only the smallest amount, in the pulling direction. These requirements can be fulfilled only with difficulty and usually require adjustment.

### SUMMARY OF THE INVENTION

Starting with this background, the task of the invention is to create a valve that has a reliably responding end position switch permitting large design freedoms, or that permits the installation of a reliably responding end position switch.

This task is achieved with the valve according to the claims presented herein.

The valve according to the invention has a valve seat and an associated valve closing element, which can be moved by a linear drive. The linear drive includes a body connected to the valve closing element (or also actuator), for example, a moving armature of a pull-type electromagnet, when the linear drive is formed as a solenoid actuator. The linear drive can also be formed as a motor drive with an adjustment spindle. A switch for detecting motion of the valve closing element or the body through a switching point is associated with the body. The switch can already be installed when the valve is delivered. It is also possible to prepare the valve with a corresponding seat for holding a switch, wherein the switch is then retrofitted at a later time, e.g., by the customer. The switching point lies directly at the point at which the valve closing element begins to lift from the valve seat or shortly before. A tappet, which is movably supported on the body, is used for activating the switch. A stroke limiting means which can move together with the body is allocated to the tappet such that the tappet stroke is limited to a maximum stroke that is significantly smaller than the stroke of the body (armature). If the tappet has moved through its maximum stroke, for example, when the valve is opened, it remains in place, while the body (magnet armature) continues its path and moves through the total opening stroke of the valve. Accordingly, the maximum relative path between the tappet and housing is exactly equal to or somewhat larger than the maximum stroke of the armature, i.e., the maximum opening stroke of the valve closing element.

Thanks to this measure, uniform end position switches can be arranged on valves and valve drives with a wide range of valve strokes. In each, the end position switch is activated in the first millimeters of the stroke and independent of how large the stroke is overall. The end position switch can be placed on the top side of the valve, i.e., set on top on the drive. Thus, a visual opening indication of the valve is also possible. The space underneath the valve closing element remains free. A pressure regulating unit can be installed there. In addition, destruction of the end position switch due to hard impacts during transport or during installation is prevented.

As mentioned, uniform switches can be used for valves with strokes having different nominal widths. These switches are switched within an extremely tight window at the beginning of the stroke. Special structural modifications of the switch are unnecessary. Also, due to the small stroke of the tappet relative to the switch, it is easy to seal the tappet. The short stroke movement of the tappet leads to only minimal wear on corresponding sealing elements, such as O-rings or sealing membranes. In addition, the switches according to the invention are built small, because they have to permit only a small stroke. The setup costs for adjusting such switches is low. It is possible to preset the switches at the factory, so that they merely have to be installed by the valve manufacturer. The switch is preferably arranged at the top end of the linear drive. From there, it monitors the beginning of the opening movement of the body (although it is arranged at the end of the opening path).

The switches according to the invention can be used not only for a wide range of valve nominal widths and opening strokes, but also for a wide range of valve closing elements or valve plate units. It is not important whether single seat plates, double seat plates, each with or without safety overtravel, are activated with the moving body and whether additional control elements, such as flow cones or the like, are connected to the valve plate.

The stroke limiting means for the tappet is preferably a fixed stop on the magnetic circuit, the drive, the drive housing, or parts of these elements. The tappet runs against this stop as soon as the body has moved a small amount from its rest position and as soon as the switch is activated. The stop can also be integrated into the switch. Conversely, the switch can also be integrated into the stop. A spring, which tensions the tappet against a moving stop provided on the body or on the valve closing element, is preferably assigned to the tappet. Here, the spring is at least strong enough that when the switch is to be activated it applies the force for activating the switch without lifting the tappet from the moving stop against which the spring presses the tappet. On the other hand, the spring is weak enough that it can be easily compressed by the linear drive of the body, i.e., for example, the magnetic circuit or a different drive, and does not significantly hinder the movement of the body (armature). Thus, if the tappet runs against its stop and remains in place, the body or the armature can continue its stroke, driven by the linear drive assigned to it, until the valve is completely opened.

For sealing the tappet against the gas space, a membrane pass-through seal can be used. This is possible due to the small stroke of the tappet relative to the stationary linear drive or switch. Preferably, however, the gas space is sealed to the tappet by a lip seal. Alternatively, an O-ring or some other suitable seal can be used.

Preferably, the valve closing element is connected to the body by means of a connection device permitting an axial relative stroke. The relative stroke is preferably greater than the maximum stroke that the tappet can execute. Thus, the opening of the valve can be indicated by a switch signal before the valve closing element is actually lifted from the valve seat. Thus, the end position switches can be built with particularly reliable closure signaling of the gas valve.

Additional details of advantageous embodiments are the subject matter of the drawings, the description, or the claims.

### BRIEF DESCRIPTION OF THE DRAWINGS

Embodiments of the invention are shown in the drawing. Shown are:

FIG. 1, a valve with end position switch and tappet stroke limiting in schematic representation,

FIG. 2, the valve according to FIG. 1 in a sectional view at a different scale,

FIG. 3, a modified embodiment of the valve in a sectional view corresponding to FIG. 2, and

FIGS. 4 to 10, different valve configurations with an end position switch according to FIG. 1 or 2, each sectioned longitudinally in a schematic view.

### DETAILED DESCRIPTION OF THE INVENTION

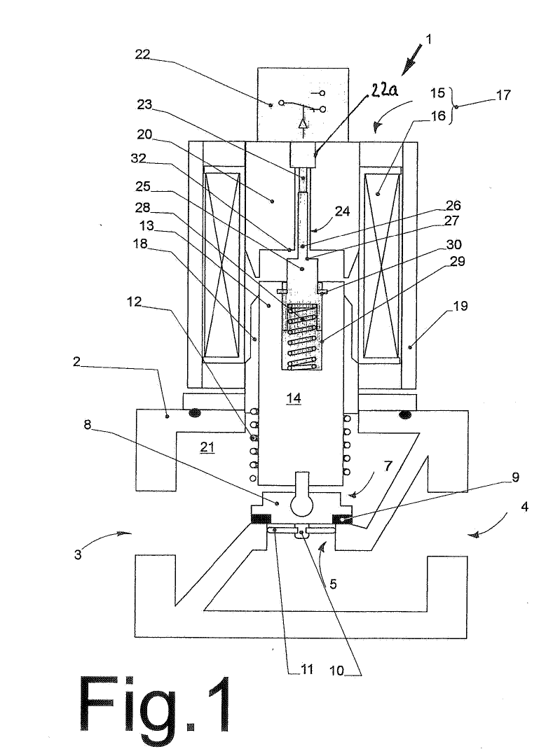

In FIG. 1, a valve 1 is shown, which acts, e.g., as a gas valve. It features a valve housing 2 with an inlet 3, an outlet 4, and a valve seat 5 formed therein. The latter is formed by an opening in an intermediate wall 6.

A valve closing element 7 is associated with the valve seat 5, for example, in the form of a valve plate 8, which is provided with a seal 9 sealing the valve seat 5. On valve plate 8 there can be a peg 10, which extends into the opening of the valve seat 5 and which supports a sealing disk 11. The latter sits within the opening established by the valve seat 5, and opens the gas passage only when it is pulled out of the valve seat 5.

The valve closing element 7 is biased, i.e., against the valve seat 5, towards its closed position, preferably by a compression spring 12. The compression spring 12 is supported with one end on the valve plate 8 and with its other end on the valve housing 2 or on an element fixed to this housing.

The valve plate 8 is connected to an approximately cylindrical body 13, which forms the armature 14 of a magnetic circuit 15. Together with a magnetic coil 16, the magnetic circuit 15 forms a linear drive 17 for moving the cylindrical body 13 and also the valve closing element 7 with this body. The magnetic circuit 15 includes a bottom magnet 18, which surrounds the cylindrical body 13 coaxially with play, an outer yoke 19 serving to guide the magnetic flux emanating from the magnet 18 outwards around the magnet coil 16, and a top magnet 20, which interacts magnetically with the top side of the armature 14. The magnets 18, 20 can be connected gas-tight to each other by means of a non-magnetic bowl, not shown in more detail, in order to seal the interior of the valve housing 2 from the outside. Thus, the interior of the valve housing with the interior enclosed by said sleeve forms a gas space 21.

A switch 22, is a type of a detector that acts as an end position switch for recognizing the opening of the valve 1, is arranged on or in the top magnet 20 on a corresponding seat, which forms a receptacle device 22a. The switch 22 can be a simple circuit closer, circuit breaker, or a change-over switch. An activating tappet 23 extends from this switch into a passage bore 24, which is preferably formed centrally and coaxially with the cylindrical body 13 in the top magnet 20.

The body 13 is provided with a tappet 25, which has an elongated projection 26 also extending into the passage bore 24. Between the tappet 25 and the projection 26 there is an annular shoulder 27, which is formed by a preferably flat annular surface and whose outer diameter is preferably significantly larger than the diameter of the passage bore 24.

The tappet 25 is supported in the body 13 so that it can move, preferably axially, i.e., in the direction in which the switch 22 is to be activated. This direction coincides with the direction in which the body 13 is moved when the linear drive 17 is activated. This direction coincides, in turn, with the opening direction of the valve 1, i.e., with the movement direction of the valve closing element 7.

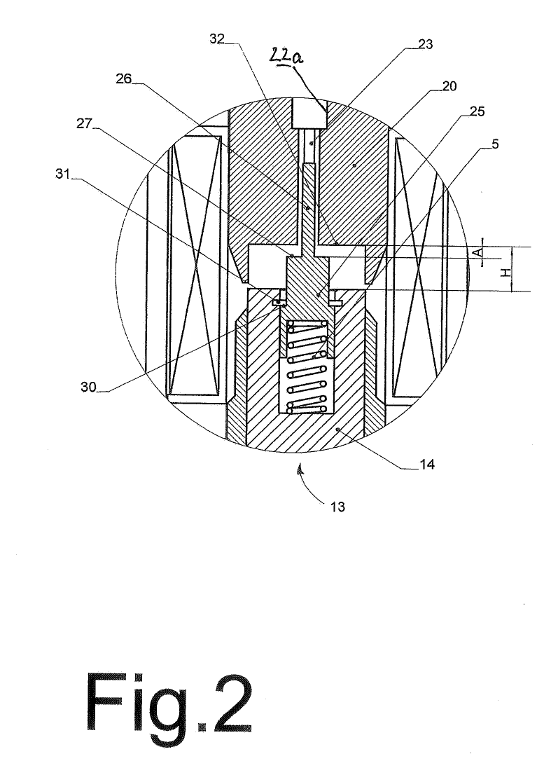

The tappet 25 is biased in a direction towards the switch 22 by a spring 28. The spring 28 sits in a preferably approximately cylindrical chamber 29, which is formed in the armature in the form of a blind hole starting from the top end of the armature 14. It presses the tappet 25 with another annular shoulder 30 against a stop formed by a snap ring 31, as follows, in particular, from FIG. 2. However, the depth of the chamber 29 is dimensioned so that the possible stroke of the tappet 25 in the chamber 29 is greater than the maximum stroke of the body 13 or of the armature 14. The maximum stroke of the armature 14 is designated in FIG. 2 with H. It is determined by the distance between the top end of the armature 13 and the bottom end 32 of the top magnet 20, when the armature 14 is located in its bottom rest position.

Between the annular shoulder 27 and the preferably flat end 32 of the magnet 20 facing the armature 14 there is a gap whose height S limits the switching stroke A of the tappet 25. This switching stroke A is greater than that necessary for activating the switch 22. The end 32 forms the stationary stop for the tappet 25.

Sealing means, such as an O-ring or the like, which are not shown in more detail, seal, e.g., the projection 26 against the magnet 20, by means of which the gas space is closed towards the top. Other sealing means are possible. In addition, the seal can also be provided at other positions or can be eliminated if the switch 22 is formed gas-tight.

The valve 1 operates as follows:

In the non-excited state of the magnetic circuit, the body 13 and also the valve plate 8 are located in the position shown in FIG. 1. The compression spring 12 acting as a closing spring presses the valve plate 8 with its seal 9 against the valve seat 5. Simultaneously, the spring 28 presses the tappet 25 with its annular shoulder 30 against the snap ring 31. The projection 26, which is in constant contact with the activation tappet 23, holds this tappet in a first switch position of the switch 22. This switch position is symbolized in FIG. 1, and corresponds to a position in which the switch outputs a first switching signal, for example, a closure signal. It indicates that the valve is closed.

Now, if the magnetic coil 16 is energized, the body 13 begins to move. Therefore, the valve closing element 7, which is connected to the body 13 axially without play, is carried along directly, so that the seal 9 is lifted from the valve seat 5. At the same time, the tappet 25 is moved upwards. This presses the activation tappet 23 upwards. Before the seal disk 11 moves out of the opening enclosed by the valve seat 5, the switch 22 switches to its other switch state. For example, it opens. Alternatively, it can change so that a first circuit is opened and a second circuit is closed.

The opening or closing or changing of the switch 22 is evaluated as a switch signal and indicates the valve open position. However, this valve open position is actually reached for the first time somewhat later, namely when the armature 14 or the body 13 moves farther upwards under the further effect of the magnetic field emanating from the magnet coil 16 and the seal disk 11 moves completely out of the valve seat 5. The gas flow is then no longer blocked. At the same time or shortly before, the annular shoulder 27 visible from FIG. 2 contacts the end 32 of the magnet 20 and thus ends the upwards movement of the tappet 25. This has no effect on the switch position of the switch 22, because this was previously changed.

However, the armature 14 continues its upwards movement, with it further overcoming the closing force of the compression spring 12 and also the compressive force of the spring 28. The movement of the armature 14 ends when this contacts the magnet 20 with its top end. The valve 1 has reached its open position. However, the switch 22 realizes only the switching stroke A according to FIG. 2 independently of how large the stroke to be realized by the armature 14 is as a whole. This can be significantly less than the total stroke H (also visible from FIG. 2).

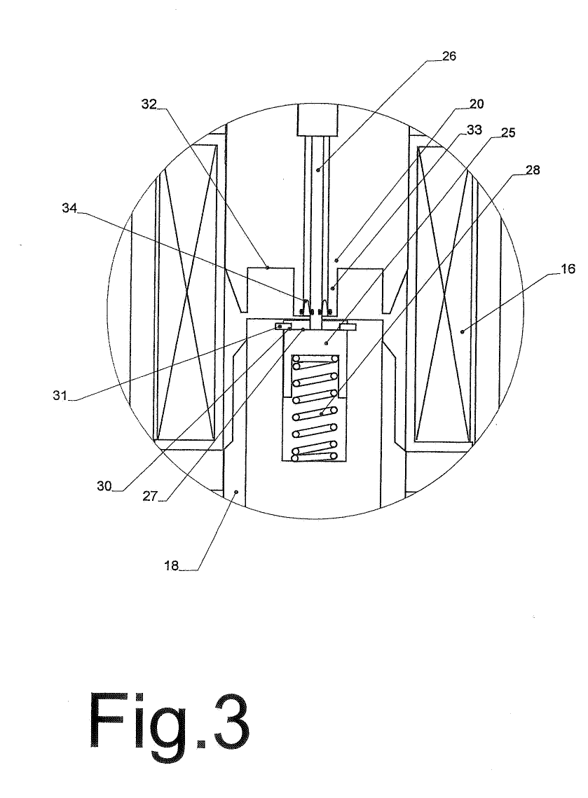

FIG. 3 shows a modified embodiment of the valve 1. The annular shoulder 27 is formed on the tappet 25 in one plane with the annular shoulder 30. However, the annular shoulders 27, 30 can also be offset axially by a small amount relative to each other. The associated stop is formed, in turn, on the magnet 20. Now, however, it is not formed against the otherwise present bottom end 32 acting as a contact surface for the armature 14, but instead by a preferably tubular projection 33, which extends coaxially around the rod-like projection 26. The projection 26 is part of the tappet 25.

Unlike the previously described embodiment, an annular membrane 34, whose inner edge is connected to the projection 26 and whose outer edge is connected to the projection [33], is arranged as a sealing device for sealing the gas space between the tubular projection 33 and the rod-like projection 26. The membrane 34 can be formed as a roll membrane. A configuration as a bellows or as a flat membrane, especially for small switching strokes, is also possible. An annular membrane, a roll membrane, or a different membrane sealing device can also be used in the embodiment according to FIGS. 1 and 2 for sealing the gas space 21 at the tappet 25. In addition, the preceding description of the embodiment according to FIGS. 1 and 2 is applicable here, both in terms of construction and also function, using the basis of the same reference symbols for the embodiment according to FIG. 3.

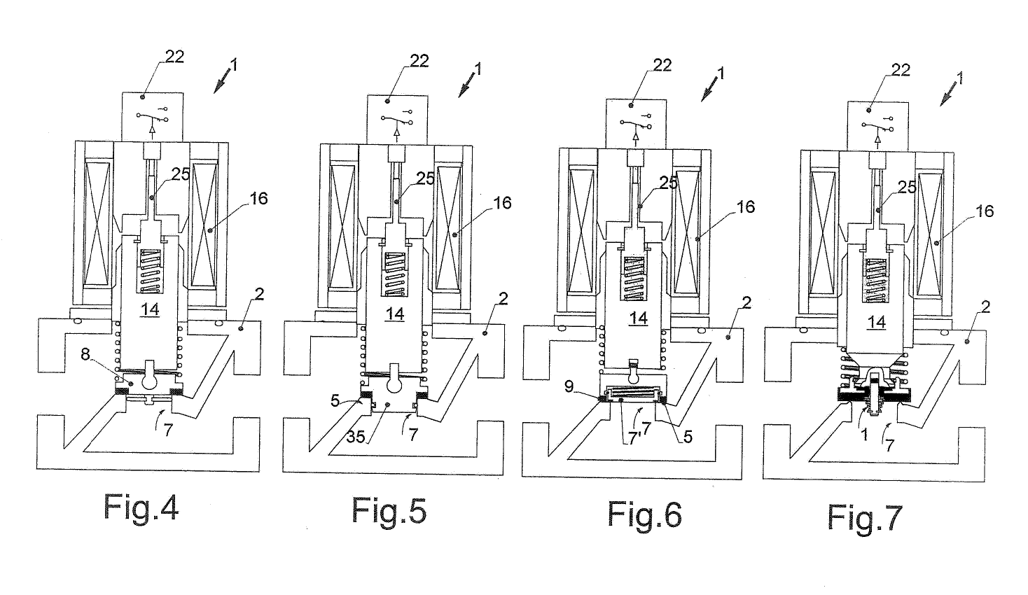

FIGS. 4 to 10 represent a combination of different embodiments of the valve closing element 7 and thus different embodiments of the valve 1. In terms of the closed position detection of the respective valve closing element 7 with the help of the switch 22, refer to the preceding description.

The valve configurations according to FIGS. 4 to 10 have in common that the gas flow is opened only when the armature 14 has executed the switching stroke of the switch 22. Thus, the closing of the valve can be indicated reliably by the switch 22. The closing is not indicated before the valve closing element 7 has interrupted the gas flow or before it has at least substantially throttled the flow.

The embodiments according to FIG. 4 essentially correspond to that of FIG. 1, with this figure being cited again for systematic reasons for comparison with the other embodiments. Refer to the preceding description.

In the embodiment according to FIG. 5, instead of the sealing disk 11 on the valve plate 8, there is a cylindrical projection 35 which projects into the opening enclosed by the valve seat 5 and which is provided with a seal on its outer peripheral surface. This seal seals the wall of the valve seat 5 and opens the gas flow only when the projection 35 is pulled out of the valve seat. Otherwise, the valve according to FIG. 5 is formed according to FIGS., 1, 2, and/or 3.

The valve according to FIG. 6 in turn differs from the previously described valves in the configuration of the valve plate 8. This plate is formed like a flat cylinder closed at the top, on whose bottom annular edge the seal 9 is held. In the flat cylindrical space enclosed by the valve plate 8 there is another valve closing element 7′, which is held with minimal axial play on the valve plate 8. A closing spring 36 biases the valve closing element 7′ downwards against the valve seat 5. In this way, it forms a common valve seat for the valve closing elements 7 and 7′. The valve closing element 7′ can be provided, if necessary, with an annular seal that sits on the valve seat 5. During the upwards movement of the armature 14, at first the valve closing element 7 lifts from the valve seat 5, while the valve closing element 7′ continues to rest on the valve seat 5 and blocks the gas flow. Only after the switch 22 has been triggered and the armature 14 moves farther upwards does the valve closing element 7′ also lift from the valve seat and open the gas flow. The tappet 25 no longer follows this upwards movement of the armature 14. It remains in place shortly after the switch 22 has closed. This applies accordingly also for all other embodiments, which have in common that the limit of the stroke of the tappet 25 is independent of the size of the armature stroke.

FIG. 7 shows an embodiment in which another valve 1′, which in the first millimeters of the opening stroke of the armature 14 opens a limited gas flow, for example, as an ignition gas flow, is formed within the valve closing element 7 held movably relative to the armature 14. The armature 14 and the associated tappet 25 are also formed like a telescope, with the upwards stroke of the tappet 25 being blocked by a stop as soon as the switch 22 has switched, and preferably before the valve 1 is completely opened.

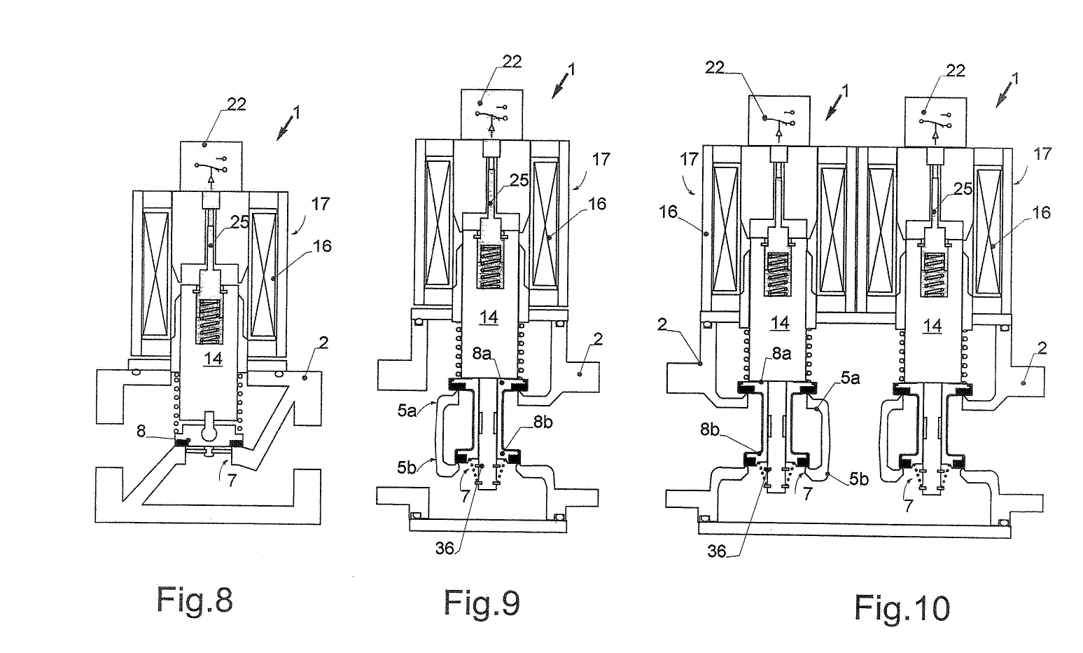

While FIG. 8 corresponds, for comparison purposes, with the valve 1 according to FIG. 1 or 4, the adjoining FIGS. 9 and 10 are directed towards modified embodiments. They are each based on double seat valves with force balancing. The valve closing elements 7 are formed as double plates with top valve plates 8a and bottom valve plates 8b. Matching valve seats 5a, 5b are assigned to the valve plates 8a, 8b. The valve plates 8a, 8b can be connected to each other via a sleeve, with this being connected with axial play to the corresponding armature 14. A projection of the armature 14 extends through the corresponding sleeve. For entraining the valve plates 8a, 8b during the upwards stroke of the armature 14, the projection can have a snap ring 36 on its bottom end where it projects from the valve plate 8b. This snap ring secures the valve plates 8a, 8b to the projection with limited axial play.

The valve 1 can be formed as a single valve according to FIG. 9 or as a double valve according to FIG. 10. Then it has one or two linear drives 17. These are provided, in turn, with the previously described switch 22, which is activated in the described way by the tappet 25. Otherwise the preceding description is applicable with the basis of the same reference symbols. This in particular applies in terms of the function of the tappet 25 and its stroke limiting. For the details of the construction of the valves according to FIGS. 9 and 10, refer to U.S. Pat. No. 6,386,234, which is incorporated herein by reference.

For closing or opening detection, a valve 1, activated preferably by a solenoid actuator, is provided with a switch 22 that is activated by means of a tappet 25 spring-mounted on the armature 14 of the solenoid actuator. A stop, for example, in the form of an annular shoulder 27 and an associated surface 32, limits the stroke of the tappet 25 with reference to the end switch 22. Preferably, the valve closing element 7 is formed so that it opens the gas flow only when the armature 14 has already executed a part (overtravel) of its opening stroke. The response point of the switch 22 is set in this first part of the opening stroke of the armature 14, in which the valve closing element 7 is not yet opened. Therefore, the switching point at the beginning of the opening stroke can be monitored with the switch 22 arranged at the end of the opening stroke of the armature 14. The stroke limitation of the tappet 25 for activating the switch 22 is preferably also set in the region of the opening stroke of the armature 14 mentioned above. However, the stop limits the stroke of the tappet 25 independently of the size of the opening stroke of the armature 14, so that one and the same switch 22 can be used for different valves with different nominal diameters and opening strokes.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A valve comprising:
a movably supported valve closing element and an associated valve seat;
a linear drive for the valve closing element which has a moving body connected to the valve closing element;
a switch for detecting a movement of the valve closing element or of the moving body through a switching point;
a tappet which is movably supported on the moving body and is designed to activate the switch; and
a stroke limiter that limits the movement of the tappet with reference to the switch.

2. The valve according to claim 1, wherein the switching point is associated with the closed position of the valve closing element.

3. The valve according to claim 1, wherein the switching point is arranged on a part of the path acted on by the linear drive and in which the valve closing element, starting from its closed position, has not yet opened the gas flow.

4. The valve according to claim 1, wherein the stroke limiter is fixed in place with reference to the switch.

5. The valve according to claim 1, wherein the stroke limiter is formed by a fixed stop.

6. The valve according to claim 1, wherein a spring, which biases the tappet against a stop provided on the moving body or the valve closing element, is assigned to the tappet.

7. The valve according to claim 6, wherein the force applied by the spring is significantly greater than the activation force of the switch.

8. The valve according to claim 1, wherein the switch is arranged outside of a gas space defined by the valve, and that the tappet is led out of the gas space towards the switch.

9. The valve according to claim 1, wherein the tappet is guided out of a gas space sealed by a membrane pass-through seal.

10. The valve according to claim 1, wherein the maximum stroke of the tappet permitted by the stroke limiter is greater than the switching stroke of the switch.

11. The valve according to claim 1, wherein the valve closing element has a seal that seals by resting on the valve seat, and other closing means designed to open the gas flow only after the switch is triggered.

12. The valve according to claim 1, wherein the moving body is connected to the valve closing element via a connection device permitting an axial relative stroke.

13. The valve according to claim 12, wherein the relative stroke is greater than the maximum stroke of the tappet.

14. A valve comprising:
a movably supported valve closing element and an associated valve seat;
a linear drive for the valve closing element, the linear drive having a moving body connected to the valve closing element;
a receptacle device for holding a switch that is used for detecting movement of the valve closing element or of the moving body through a switching point;
a tappet which is movably supported on the body and which is designed to activate the switch;
a stroke limiter that limits the movement of the tappet with reference to the receptacle device.

15. The valve according to claim 14, wherein the receptacle device has a sealing device for gas-tight installation of the switch.

16. The valve according to claim 14, wherein the receptacle device is designed to hold the switch in a defined position.

17. The valve according to claim 16, wherein the receptacle device is a stepped bore.
